(19) United States
(12) Patent Application Publication
(10) Pub. No.: US 2017/0316502 A1
(43) Pub. Date: Nov. 2, 2017

(54) TECHNIQUES FOR AUTOMATED ORDER MATCHING

(71) Applicant: CURRENEX, INC., NEW YORK, NY (US)

(72) Inventor: Stephen R. Schonberg, Alpine, NJ (US)

(21) Appl. No.: 15/582,008

(22) Filed: Apr. 28, 2017

Related U.S. Application Data
(60) Provisional application No. 62/328,941, filed on Apr. 28, 2016.

(51) Int. Cl. G06Q 40/04; G06Q 10/08

(52) U.S. Cl. CPC G06Q 40/04; G06Q 10/087

(57) ABSTRACT

Various embodiments are generally directed to techniques for automated order matching. Techniques described herein may provide an automated order matching system that provides advantages of the last look technique, yet minimizes or eliminates the ability of makers to manipulate markets. In some embodiments, one or more electronic orders may be received at a server, the one or more electronic orders comprising orders to buy or sell currency. At least one electronic order of the one or more electronic orders may be automatically identified as an OXQ type, wherein OXQ type orders include a trade acknowledge return time (TART) and maximum adverse change (MAC). One or more orders may be prioritized primarily based upon TART and secondarily based upon MAC. The one or more orders may be automatically matched based upon determined.

### RELATED APPLICATIONS

This application claims the benefit of priority under 35 U.S.C. §119(e) to U.S. Provisional Application No. 62/328,941, entitled “TECHNIQUES FOR AUTOMATED ORDER MATCHING” filed Apr. 28, 2016, which is hereby incorporated by reference in its entirety.

### BACKGROUND

Some global exchanges, such as many ECNs in the foreign exchange market, currently offer a technique called “last look,” which allows a maker, or liquidity provider, to reject orders that match a previously quoted price. For example, a maker may publish a price quote to the market and orders may be placed by takers corresponding to the published price quote. However, the market may shift during the time between when the price quote was given and the orders are received. To protect the maker, last look allows the maker to evaluate market conditions after a Request for Execution (RFE) is received, and reject the order if desired.

Last look provides several advantages to makers. For example, makers have the ability to make markets in multiple pools without taking multiples of risks. In other words, makers can show price quotes to many markets with the intent to transact in just one. Further, the last look technique allows makers to provide liquidity to a diverse pool of participants filtering out (rejecting) extremely aggressive and/or arbitrage-oriented requests. However, despite advantages to makers, last look could allow knavish makers the ability to front run or spoof markets by publishing price quotes without the intent to transact with matching orders. Due to increased scrutiny of markets by regulators, the technique may become highly regulated or banned. Unconditionally firm orders may be used as an alternative, however, this technique inherently lacks flexibility. Thus, new techniques for order matching are desired.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for automated order matching. Techniques described herein may provide an automated order matching system that provides advantages of the last look technique, yet minimizes or eliminates the ability of makers to manipulate markets and/or disadvantage takers. In some embodiments, one or more electronic orders may be received at a server, the one or more electronic orders comprising orders to buy or sell currency. At least one electronic order of the one or more electronic orders may be automatically identified as an OXQ type, wherein OXQ type orders include a trade acknowledge return time (TART) and maximum adverse change (MAC). One or more orders may be prioritized primarily based upon TART and secondarily based upon MAC. The one or more orders may be automatically matched based upon determined priority to create a matched trade and a trade confirmation may be generated.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system.

FIG. 2 illustrates an embodiment of a system.

FIG. 3 illustrates a logic flow according to an embodiment.

FIG. 4 illustrates a logic flow according to an embodiment.

FIG. 5 illustrates a logic flow according to an embodiment.

FIG. 6 illustrates an example according to an embodiment.

FIG. 7 illustrates an example according to an embodiment.

FIG. 8 illustrates an embodiment of a centralized system according to an embodiment.

FIG. 9 illustrates an embodiment of a distributed system according to an embodiment.

FIG. 10 illustrates an embodiment of a computing architecture.

FIG. 11 illustrates an embodiment of a communications architecture.

### DETAILED DESCRIPTION

Various embodiments are generally directed to techniques for automated order matching. The systems and techniques described herein (referred to as OXQ) describe an automated order matching system including many of the advantages of a last look (OXP) system, while avoiding the rigid nature of an unconditionally firm system (OXO) and neutralizing the shortcomings of last look. In one example, described embodiments may limit, or prevent, information leakage to market participants. The prevention of information leakage to market participants is of paramount importance in maintaining the integrity of markets for participants and regulators. Using an automated and secure real-time order matching system, market participants are not exposed to information, such as price quotes, actions taken with respect to price quotes, or inactions taken with respect to price quotes.

Some embodiments provide real-time, automated, order matching, which prioritizes faster and more generous terms over others. Deal terms outside of price have considerable commercial value, and the ability to process these in real-time, and in an automated fashion, which prevents information leakage, allows the full commercial value of a particular trade to be realized. Further, prioritizing faster and more generous terms using a secure, automated, real-time system, incentivizes parties to deal using such terms, creating increased market liquidity.

In another example, current systems utilizing last look can not allow two last look liquidities from dealing with one another, since each would require a last look at the deal before a transaction is confirmed. Embodiments described herein provide many of the advantages of last look, but also allow for any two parties to transact, greatly increasing the size of compatible parties within the market.

While many of the examples described herein focus on foreign exchange (FOREX) markets, the systems and techniques described herein are also applicable to other trading markets including, but not limited to fixed income, credit, commodity, currency, equity, futures, derivatives, and swap instruments. Further, while specific currencies, amounts, and rates may be used for purposes of illustration, it can be appreciated that other amounts, currencies, and rates may be used in various implementations.

Some embodiments describe an automated order matching system that allows market participants to submit electronic orders designating pricing along with other terms, such as trade acknowledge return time (TART) and maximum adverse change (MAC). TART may represent the participant's timing preference, i.e., must receive a response on a match within a set timeframe. TART may be represented in milliseconds (ms), however, other time periods may be used in some embodiments. MAC may represent the maximum adverse change in the price that a maker will accept, and acts to provide some of the advantages as last look techniques, while maintaining security and market integrity. In FOREX, “pips” refers to the “price interest point,” a measurement of the amount of change in the exchange rate for a currency pair. Thus, a maker may provide an electronic order that includes, inter alia, pricing information, 25 ms TART value, and 0.2 pips MAC value. Using this information, the systems and techniques describes herein may provide secure, real-time, automated order matching between parties that increases liquidity in the markets, preserves many advantages of last look techniques, and at the same time, reduces or eliminates market information leakage.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

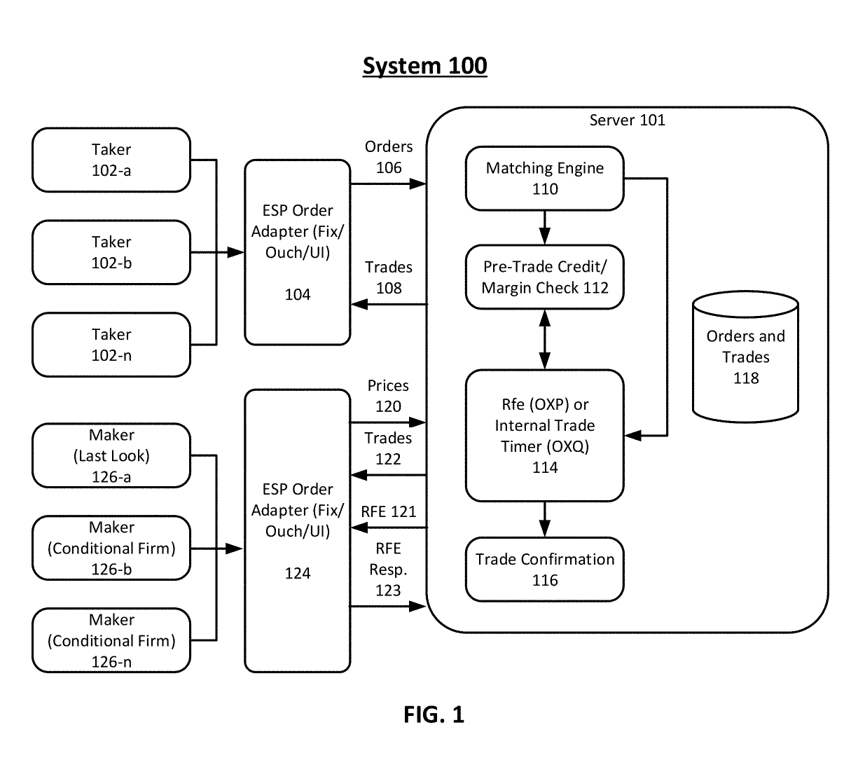

FIG. 1 illustrates a block diagram for a system 100. The system 100 may comprise one or more components configured to operate according to the embodiments and logic flows described herein. Although the system 100 shown in FIG. 1 has a limited number of elements in a certain topology, it may be appreciated that the system 100 may include more or less elements in alternate topologies as desired for a given implementation. The system 100 may include a server 101, which may be generally operative to interact with one or more components or modules within system 100. Server 101 may include one or more processing units, storage units, network interfaces, or other hardware and software elements, described in more detail below.

In an embodiment, each component may comprise a device, such as a server, comprising a network-connected storage device or multiple storage devices, such as one of the storage devices described in more detail herein. In an example, taker components 102-a-n and maker components 126-a-n may include one or more devices used to access software or web services provided by server 101. For example, taker components 102a-n and maker components 126-a-n may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a wearable computing device such as a smart watch, a server, a server array or server farm, a web server, a network server, an Internet server, a work station, a mini-computer, a mainframe computer, a supercomputer, a network appliance, a web appliance, multiprocessor systems, processor-based systems, or any combination thereof.

In various embodiments, server 101 and the other components of system 100 may comprise or implement multiple components or modules. As used herein the terms “component” and “module” are intended to refer to computer-related entities, comprising either hardware, a combination of hardware and software, software, or software in execution. For example, a component and/or module can be implemented as a process running on a processor, a hard disk drive, multiple storage drives (of optical and/or magnetic storage medium), an object, an executable, a thread of execution, a program, and/or a computer. By way of illustration, both an application running on a server and the server can be a component and/or module. One or more components and/or modules can reside within a process and/or thread of execution, and a component and/or module can be localized on one computer and/or distributed between two or more computers as desired for a given implementation. The embodiments are not limited in this context.

The various devices within system 100, and components and/or modules within a device of system 100, may be communicatively coupled via various types of communications media as indicated by various lines or arrows. The devices, components and/or modules may coordinate operations between each other. The coordination may involve the uni-directional or bi-directional exchange of information. For instance, the devices, components and/or modules may communicate information in the form of non-transitory signals communicated over the communications media. The information can be implemented as signals allocated to various signal lines. In such allocations, each message is a signal. Further embodiments, however, may alternatively employ data messages. Such data messages may be sent across various connections. Exemplary connections within a device include parallel interfaces, serial interfaces, and bus interfaces. Exemplary connections between devices may comprise network connections over a wired or wireless communications network.

In various embodiments, the components and modules of the system 100 may be organized as a distributed system. A distributed system typically comprises multiple autonomous computers that communicate through a computer network. The computers interact with each other in order to achieve a common goal, such as solving computational problems. For example, a computational problem may be divided into many tasks, each of which is solved by one computer. A computer program that runs in a distributed system is called a distributed program, and distributed programming is the process of writing such programs. Examples of a distributed system may include, without limitation, a client-server architecture, a 3-tier architecture, an N-tier architecture, a tightly-coupled or clustered architecture, a peer-to-peer architecture, a master-slave architecture, a shared database architecture, and other types of distributed systems. It is worthy to note that although some embodiments may utilize a distributed system when describing various enhanced techniques for data retrieval, it may be appreciated that the enhanced techniques for data retrieval may be implemented by a single computing device as well. The embodiments are not limited in this context.

In an embodiment, taker components 102-a-n may include one or more computing modules associated with banks, customers, or other entities that may participate in trading positions in a market, such as the FOREX market. It is worthy to note that “a” and “n” and similar designators as used herein are intended to be variables representing any positive integer. Thus, for example, if an implementation sets a value for n=5, then a complete set of takers 102-n may include takers 102-1, 102-2, 102-3, 102-4, and 102-5. The embodiments are not limited in this context and it will be appreciated that in various embodiments different values of n and other designators may be used. Each taker component 102 may be configured to send one or more orders 106 for a trade of an asset, such as currency, from clients or customers. Orders 106 may be placed in a variety of ways, including through automated phone systems, websites, smartphone applications, and the like.

In an embodiment, orders 106 may be placed via ESP (executable streaming price) order adapter 104, which may also provide trade confirmations 108 to takers 102. ESP order adapter 104 may provide a user interface to taker components 102, which may display available prices 120, which may be received by maker components 126. The user interface may provide a plurality of fields for users to enter the parameters discussed below. In addition, the user interface may be configured to prevent the display of market information, and may be limited to include trade confirmations, which can serve to prevent market manipulation. ESP order adapter 104 may support one or more protocols, such as Financial Information eXchange (FIX) or OUCH, and communicate using such protocols. While FIX and OUCH are described as exemplary protocols, it can be appreciated that other protocols may be used.

In an embodiment, orders 106 may be electronic orders and each of orders 106 may include various fields, each with a parameter, which may comprise an order data set. By way of example and not limitation, each order may contain a TART value, MAC value, client order ID, Currency (e.g., dealt currency, base), Side (e.g., buy, sell), Symbol (currency pair, e.g., EUR/USD), Transaction Time (e.g., transaction timestamp), Order Quantity (e.g., specified order amount), Quantity Currency (e.g. currency unit for Order Quantity), Order Type (e.g., order type, such as “L” for limit), and Account (e.g., optional fund subsidiary ID)

Each taker component 102 may be responsible for one or more orders 106 sent to server 101 via ESP order adapter 104. Orders may be one or more data messages sent via an intermediary system, such as ESP order adapter 104, which may include a trading platform operated by a third-party, or a trading platform associated with server 101, which may provide secure access to server 101. In one example, ESP order adapter 104 may implement the FIX protocol, which allows for international, real-time, exchange of information related to securities transactions and markets and/or the OUCH protocol. However, it can be appreciated that other platforms may be used. In other embodiments, an intermediary platform may not be used. Each order may include information indicating whether the order is a buy or a sell, the specific currency being bought or sold, the specific amount of currency to be bought or sold, the other currency desired, the date of trade settlement, the specific benchmark rate fixing desired, and associated bank.

In an exemplary embodiment, a plurality of orders 106 may be sent from a plurality of taker components 102 to server 101, via ESP order adapter 104. Likewise, makers 126 may submit prices 120 via ESP order adapter 124, which is substantially similar to ESP order adapter 104. Each maker 126 may include an order type preference, such as OXQ, OXP, or OXO. Server 101 may store orders, prices, and trades in database 118. Specifically, initial orders, intermediate trades, and final trades may be stored within database 118. Prices 120 may be stores within database 118 along with other parameters received within each order data set, and used by matching engine 110 to coordinate transactions between takers 102 and makers 126. Likewise, in some embodiments, RFE 121 may be sent from server 101 via ESP order adapter 124 to makers 126. In response, makers 126 may send RFE responses 123 to server 101 via ESP order adapter 124, which may be stored in database 118.

In some embodiments, matching engine 110 may be configured to receive orders 106 from taker components 102 at server 101, which may be sent via ESP order adapter 104, as discussed above. Matching engine 110 may also be configured to receive prices 120 from maker components 126 at server 101, which may be sent via ESP order adapter 124. Matching engine 110 may implement OXQ, OXP, and/or OXO order matching techniques described herein. For example, in the case of OXQ, each received order 106 and price 120 may include data indicating, inter alia, TART and MAC values. In addition, a time stamp may be associated with the order, either by ESP order adapter 104, ESP order adapter 124, server 101, or matching engine 110. Received timestamps may be stored within database 118 and used by timer 114 to determine whether an order has expired.

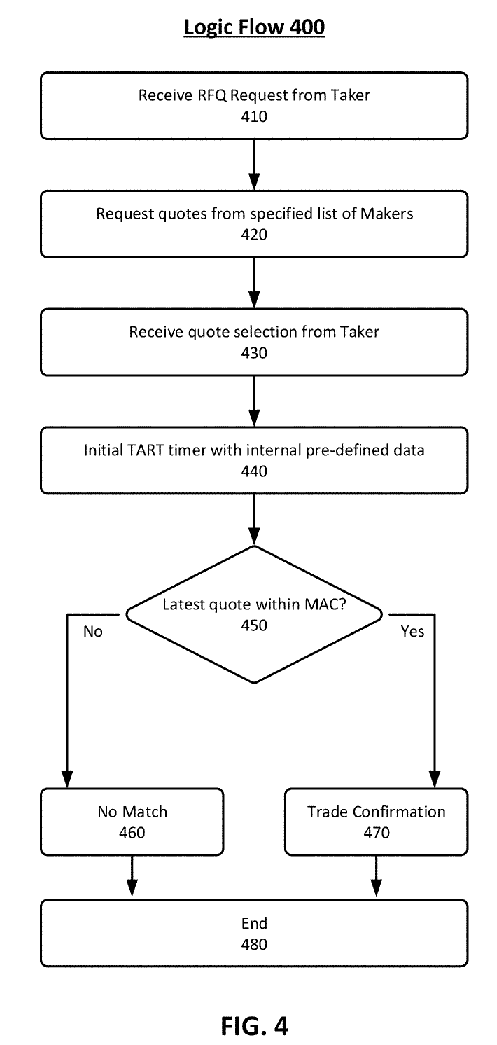

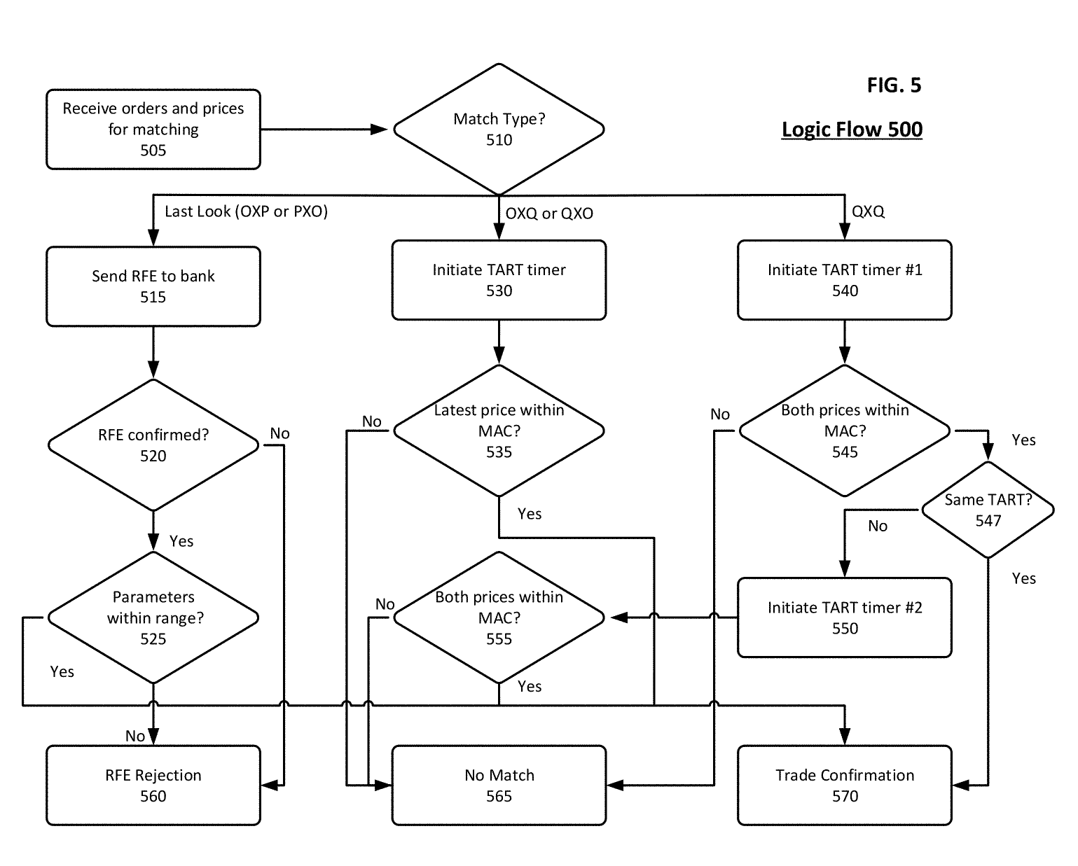

Matching engine 110 may sort and prioritize orders using various factors. In an embodiment, orders may be sorted first by price, then speed of response, and then time. For example, price may be the first factor used in matching orders, matching takers and makers who have submitted the same price. Second, speed of response may be used to sort different types of orders, which acts as a proxy for firmness. In an example, OXO (unconditionally firm) are ranked first, because they are the firmest of the three order types (OXO, OXQ, OXP). OXQ orders are ranked second and multiple OXQ orders are sorted first by fastest to slowest TART and then by largest to smallest MAC. OXP orders are ranked last, which assumes they have the longest response time and, thus, are the least firm. Once sorted and prioritized, matching engine 110 may perform automatic matching of orders in accordance with one or more of the logic flows described herein, such as within FIG. 4 or FIG. 5.

In some embodiments, the workflow within server 101 may change based upon order type. In the case of OXP orders, matching engine 110 may perform a pre-trade credit/margin check 112, as described below, and then access component 114 to perform a RFE (request for execution). In the case of OXQ, matching engine 110 may first access component 114 to initiate an internal trade timer in conjunction with TART values to during the matching process. Once a match is determined by matching engine 110, a pre-trade credit/margin check 112 may be performed, as described below.

With respect to workflows for all order types, pre-trade credit check and margin checks by component 112 may be performed for each trade. Pre-trade credit check component 112 may be performed using known credit-check systems and techniques, and may be used to verify the credit of each party to a transaction and reserve adequate credit to place an order. Pre-credit check component 112 may be configured to extract credit information, such as name and tax identification number, from an order and perform a credit check using such information. Once a pre-trade credit check has been completed, and parties to the transaction are verified, final trades 108 and 122 may be generated by trade confirmation component 116, which may be reported to taker components 102 and maker components 126, respectively.

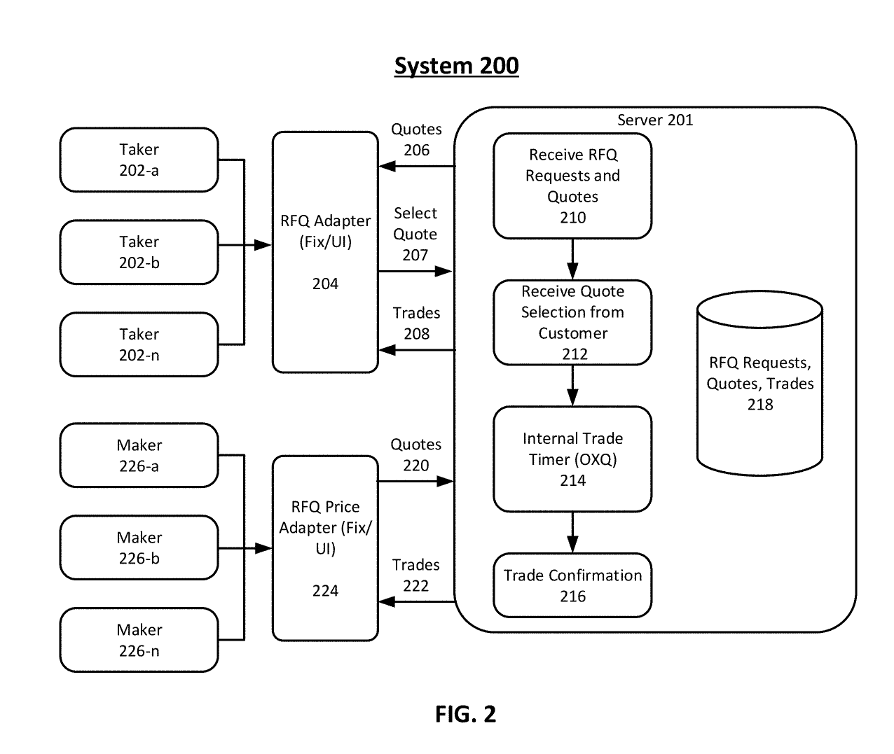

FIG. 2 illustrates a block diagram for a system 200. System 200 illustrates an embodiment in which an RFQ (request for quote) system, rather than the ESP system described in FIG. 1, may be used. Many components of system 200 are similar to those described above with respect to FIG. 1. For example, takers 202, makers 226, and server 201 may be substantially similar to like-numbered components of FIG. 1. However, rather than using an ESP order adapter, RFQ adapter 204 and RFQ price adapter 224 may be used. In RFQ, takers may intentionally send a request for a price to a finite, sometimes predetermined, set of makers. The taker may then select a price to transact against.

In conventional RFQ systems, makers who have submitted quotes may require a last look, which leads to rejected RFEs being returned to takers in some cases. In an example, multiple quotes from makers may be at the same rate, however, the taker may be unaware of the trade-acceptance criteria of each maker. Thus, for a particular order, a taker may accept a quote from a first maker, and be ultimately rejected, whereas a second maker with the same quote may have accepted. Using an OXQ protocol within server 201 may alleviate some of the disadvantages to takers.

As shown within FIG. 2, RFQ adapter 204 and RFQ price adapter 224 may include a UI for takers 202 and makers 226 to request, submit, and accept quotes for orders. The UI may, in some embodiments, be configured to prevent the disclosure of market information, except for quote requests, quote submissions, and the notification of confirmed trades. RFQ adapter 204 and RFQ price adapter 224 may utilize the FIX protocol, however, it can be appreciated that other similar protocols may be used in some embodiments. A taker 202 may receive a quote 206 via RFQ adapter 204, the quote 206 being stored within database 218. RFQ request component 210 may receive quote 206, and communicate to takers 202, which may have preferred makers, price criteria, and OXQ criteria such as MAC and TART values, all or some of which may be indicated by quote 206.

In some embodiments, makers 226 may submit quotes 220 via RFQ price adapter, the quotes 220 may be submitted periodically, or on demand, and may be stored within database 218. Quotes 220 may include price information along with OXQ criteria such as MAC and TART values. RFQ request component 210 may receive quotes 220, and may respond to takers 202. In some embodiments, RFQ request component 210 may deliver quotes to takers 202 based upon maker preferences of takers 202 and one or more OXQ criteria, such as MAC and TART values. Upon receiving quotes, takers 202 may make quote selections 207, which may include OXQ criteria, such as MAC and TART values. Server 201 may store quote selections in database 218.

Once makers 226 have submitted quotes 220, and takers have submitted selected quotes, server 201 may use OXQ component 214, which may include an internal trade timer. OXQ component 214 may use one or more of the logic flows described herein to perform automated order matching based upon OXQ parameters such as MAC and TART. In some embodiments, makers 226 may submit MAC and TART values based upon individual preferences. In other embodiments, makers 226 may be required to use standardized MAC and TART values. In either case, MAC and TART values from makers 226 may be disclosed to takers 202, either within a UI of RFQ adapter 204, or using other methods.

During the automated matching process, if a taker 202 has a quote rejected due to fluctuation in price outside of MAC, for example, server 201 may generate an “internal deny” and continue automated matching of the taker's quote. This is in contrast to conventional last look systems, where both the taker and the maker would know of the rejection, which may leak market information to the maker. Likewise, during the automated matching process, makers are not exposed to market information related to quote requests and selected quotes from takers. In some embodiments, the market information shared by server 201 may be limited to trade confirmations 208 and 222 with takers and makers, which may merely identify the terms of the trade and the winning maker.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer). For example, a logic flow may be implemented by a processor component executing instructions stored on an article of manufacture, such as a storage medium or a computer-program product. A storage medium may comprise any non-transitory computer-readable medium or machine-readable medium, such as an optical, magnetic or semiconductor storage. The storage medium may store various types of computer executable instructions, such as instructions to implement one or more disclosed logic flows. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

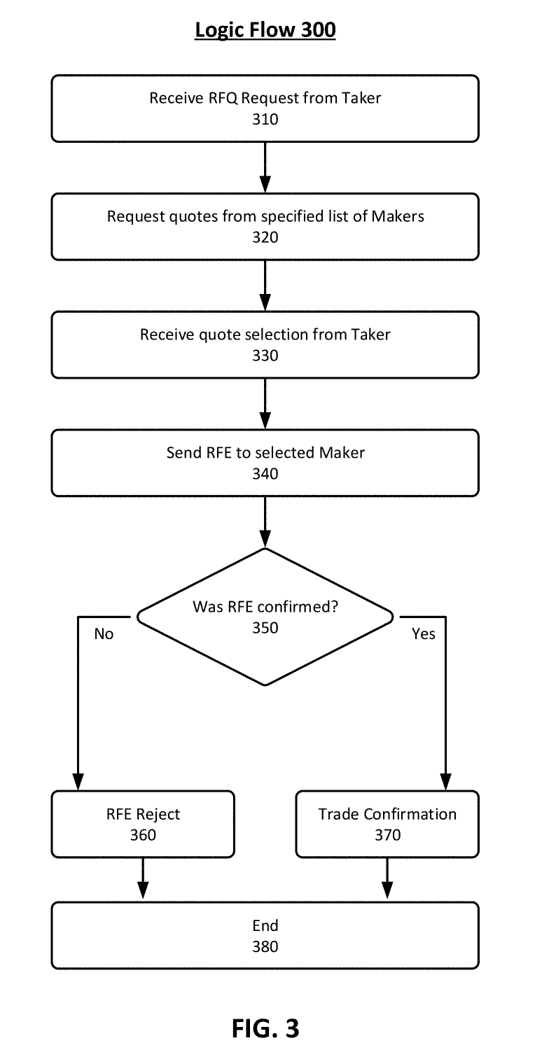

FIG. 3 illustrates one embodiment of a logic flow 300 of an OXP technique. The logic flow 300 may be representative of some or all of the operations executed by one or more embodiments described herein. For instance, the logic flow 300 may be representative of some or all of the operations executed by system 100 or 200, and the components and modules included therein.

At 310, A RFQ request may be received from a taker, which may include a request to buy or sell currency in a foreign exchange market. As set forth above, the RFQ request may include a price, timestamp, and one or more parameters. In addition, RFQ requests may include a specified, and pre-determined list of makers for which quotes are requested.

At 320, quotes may be requested from a specified list of makers. Maker quotes may include the same set of data as taker requests, such as price and other parameters. At 330, a quote selection may be received from a taker and, at 340, sent to the selected maker as a RFE (request for execution). Using an OXP technique, the selected maker may decide whether to confirm or deny the received RFE. If the market has not moved, or has moved favorably to the maker, the maker is likely to confirm the RFE at 350, which results in a trade conformation at 370. If the market has moved against the maker, the maker may take a “last look,” and deny the RFE at 350, resulting in a RFE rejection at 360. The logic flow ends at 380.

FIG. 4 illustrates one embodiment of a logic flow 400 of an OXQ technique. The logic flow 400 may be representative of some or all of the operations executed by one or more embodiments described herein. For instance, the logic flow 400 may be representative of some or all of the operations executed by system 100 or 200, and the components and modules included therein.

At 410, A RFQ request may be received from a taker, which may include a request to buy or sell currency in a foreign exchange market. As set forth above, the RFQ request may include a price, timestamp, and one or more parameters. In an embodiment, the RFQ request may include MAC and TART values. In addition, RFQ requests may include a specified, and pre-determined list of makers for which quotes are requested.

At 420, quotes may be requested from a specified list of makers. Maker quotes may include the same set of data as taker requests, such as price and other parameters, such as MAC and TART values. At 430, a quote selection may be received from a taker and, at 440, an initial TART timing component may begin running. The TART timer may run while automated matching takes place, and at the end of a TART value (e.g. 25 ms) a latest quote may be determined to be within the MAC of the maker at 450. If, at the end of the TART timer, the maker's latest quote is within their MAC, a match is made and a trade confirmation is generated at 470. If at the end of the TART timer, the latest quote is outside of the MAC of either party, no match is made at 460. The logic flow ends at 480.

FIG. 5 illustrates a logic flow 500 for automated order matching, according to an embodiment. The logic flow 500 may be representative of some or all of the operations executed by one or more embodiments described herein. For instance, the logic flow 500 may be representative of some or all of the operations executed by system 100 or 200, and the components and modules included therein.

At 505, orders and prices for matching may be received from makers and takers. As set forth above, orders may include prices along with other information, such as preferred makers (when receiving from a taker), and OXQ information such as MAC and TART values. In addition, orders may include a type, in which an order may be characterized as OXQ or OXP. OXP orders may not include OXQ parameters, for example. Matching may take place based upon price, and based upon the prioritization discussed above. When a taker and maker have been matched, a match type may be determined.

At 510, order types may be determined. For example, orders may be of the type OXP (last look), OXQ (one side including OXQ), or QXQ (both sides including OXQ). As set forth above, OXP orders may be processed according to last look techniques and OXQ/QXQ orders may be processed according to automated order matching, described within various embodiments described herein.

At 515, it may be determined that an order is of OXP (or PXO) type, and an RFE may be sent to a maker based upon a determined match.

At 520, a determination may be made as to whether the RFE is confirmed. If not, a RFE rejection is generated at 560. If the RFE is confirmed a determination may be made at 525 as to whether parameters are within range. If so, a trade confirmation may be generated at 570. If parameters are outside of a given range, an RFE rejection may be generated at 560.

At 530, it may be determined that an OXQ or QXO order type has been matched. Since one order of a matched pair is of OXQ type in this order, one set of OXQ parameters may be available. For example, a MAC and TART value may be used to determine whether a trade confirmation may be made. At 530, a TART timer may be started based upon a TART value associated with at least one value. At 535, upon expiration of the TART timer, it may be determined whether a current price is within a MAC. If so, a trade confirmation may be generated at 570. If not, no match may be made at 565.

At 540, it may be determined that two OXQ type orders have been matched. In this case, two sets of MAC and TART values may be used to determine whether a trade confirmation can be generated. A first timer may be started at 540. At the expiration of the first timer, a check may be made at 545 determining whether both prices are within MAC. If not, no match may be made at 565.

If both prices are within MAC at 545, it is determined whether both parties have the same TART at 547. If so, a trade confirmation may be made at 570. If not, the second, different, timer may be started at 550. It should be noted that the first TART timer will generally be the difference between a first TART and a second TART. In an example, given a first TART of 500 ms and a second TART of 100 ms, the first TART timer will be 400 ms and the second TART timer will be 100 ms. At the conclusion of the second TART timer, it may be again determined whether both prices are within MAC at 555. If not, no match will be made at 656. If so, a trade confirmation may be generated at 570.

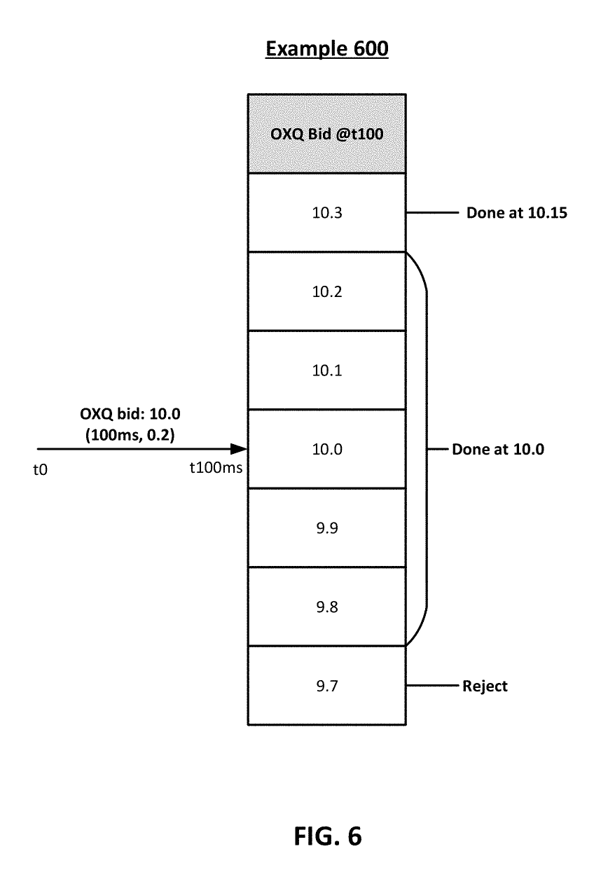

FIG. 6 illustrates an example according to an embodiment. In example 600, an OXO aggressor may be sweeping many levels, and thus, the possibility of a maker actually improving their price in that window may be very low, possibly near zero, hence an edge-edge case may exist. In an example, symmetry may be desirable and may be enforced in various ways. If the market is moving in favor of a taker, rejecting an order may allow a potential re-match at a better price. However, if volatility in the market continues and then the market moves adversely, the original match would have been optimal. In a first example, symmetry may be enforced and the order may be rejected even though both parties want to trade. As illustrated in example 600, if OXQ 10.0 bidder is 10.3 or higher bid at t100 (after 100 ms TART), embodiments herein may reject aggress attempt at 10.0 to serve interests of an OXO taker. In a second example, embodiments may allow for edge case asymmetry and accept the trade. The trade may be accepted at the new posted rate (10.3 in example 600), or at a rate that splits the price improvement such as 10.15 (between original price and new price that is beyond MAC—both sides share in asymmetry). The embodiments are not limited in this context.

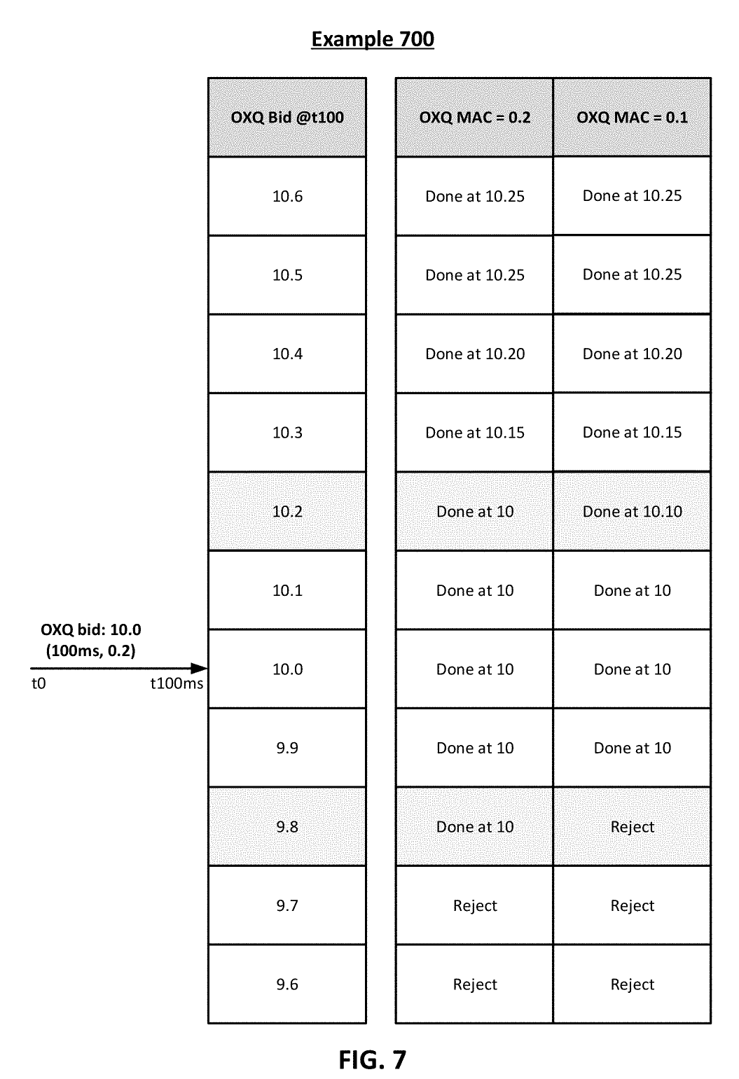

FIG. 7 illustrates an example 700 according to an embodiment. Example 700 illustrates two cases, which may be executed using the automated techniques described herein: an OXQ maker with 0.2 MAC and an OXQ maker with 0.1 MAC. As set forth within example 700, the OXQ maker with the more generous MAC (0.2) may receive an advantage over the maker with the 0.1 MAC when its price improves (e.g. from a 10.0 bid to 10.2 bid), but also must accept the trade when it has widened their price (e.g. from a 10.0 bid to a 9.8 bid). This example may give a slight incentive for makers with larger MACs (in addition to the preference in queue priority). The embodiments are not limited in this context.

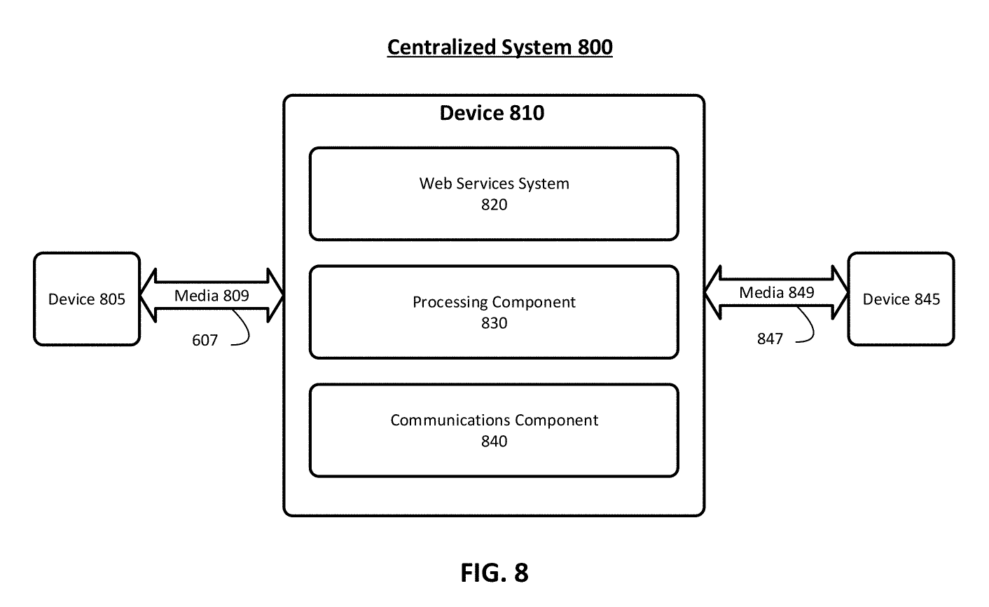

FIG. 8 illustrates a block diagram of a centralized system 800. The centralized system 800 may implement some or all of the structure and/or operations for the web services system 820 in a single computing entity, such as entirely within a single device 810.

The device 810 may comprise any electronic device capable of receiving, processing, and sending information for the web services system 820. Examples of an electronic device may include without limitation a computer, a personal computer (PC), a desktop computer, a laptop computer, a notebook computer, a netbook computer, a handheld computer, a tablet computer, a server, a server array or server farm, a web server, a network server, an Internet server, a work station, a main frame computer, a supercomputer, a network appliance, a web appliance, a distributed computing system, multiprocessor systems, processor-based systems, wireless access point, base station, subscriber station, radio network controller, router, hub, gateway, bridge, switch, machine, or combination thereof. The embodiments are not limited in this context.

The device 810 may execute processing operations or logic for the web services system 820 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 810 may execute communications operations or logic for the web services system 820 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 809, 849 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 810 may communicate with other devices 805, 845 over a communications media 809, 849, respectively, using communications signals 807, 847, respectively, via the communications component 840. The devices 805, 845, may be internal or external to the device 810 as desired for a given implementation. Examples of devices 805, 845 may include, but are not limited to, a mobile device, a personal digital assistant (PDA), a mobile computing device, a smart phone, a telephone, a digital telephone, a cellular telephone, ebook readers, a handset, a one-way pager, a two-way pager, a messaging device, consumer electronics, programmable consumer electronics, game devices, television, digital television, or set top box.

For example, device 805 may correspond to a client device such as a phone used by a user. Signals 807 sent over media 809 may therefore comprise communication between the phone and the web services system 820 in which the phone transmits a request and receives a web page in response.

Device 845 may correspond to a second user device used by a different user from the first user, described above. In one embodiment, device 845 may submit information to the web services system 820 using signals 847 sent over media 849 to construct an invitation to the first user to join the services offered by web services system 820. For example, if web services system 820 comprises a social networking service, the information sent as signals 847 may include a name and contact information for the first user, the contact information including phone number or other information used later by the web services system 820 to recognize an incoming request from the user. In other embodiments, device 845 may correspond to a device used by a different user that is a friend of the first user on a social networking service, the signals 847 including status information, news, images, or other social-networking information that is eventually transmitted to device 805 for viewing by the first user as part of the social networking functionality of the web services system 820.

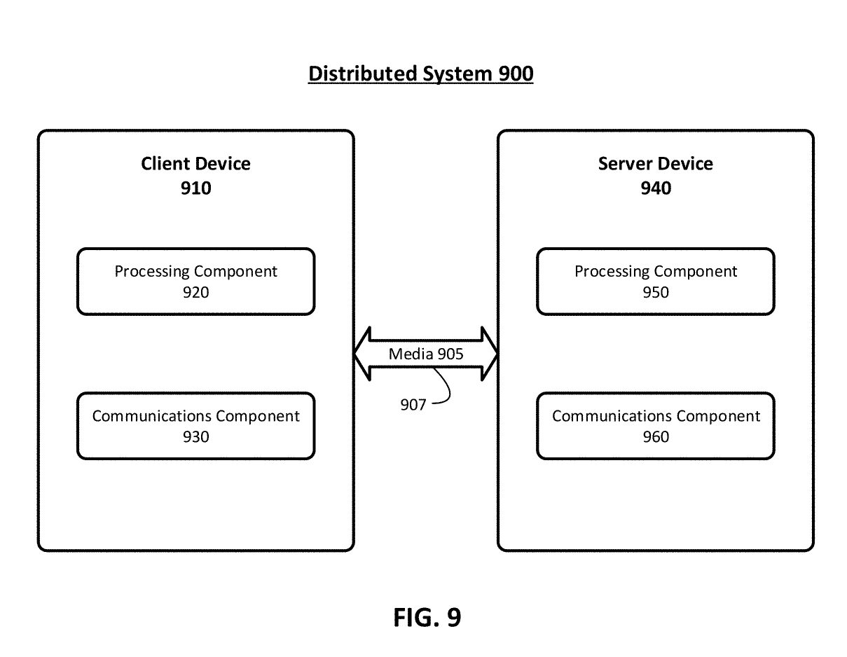

FIG. 9 illustrates a block diagram of a distributed system 900. The distributed system 900 may distribute portions of the structure and/or operations for the disclosed embodiments across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a server device 940. In general, the client device 910 and the server device 940 may be the same or similar to device 910 as described with reference to FIG. 8. For instance, the client device 910 and the server device 940 may each comprise a processing component 920, 950 and a communications component 930, 960 which are the same or similar to the processing component 830 and the communications component 840, respectively, as described with reference to FIG. 8. In another example, the devices 910 and 940 may communicate over a communications media 905 using media 905 via signals 907.

The client device 910 may comprise or employ one or more client programs that operate to perform various methodologies in accordance with the described embodiments. In one embodiment, for example, the client device 910 may implement some steps described with respect client devices described in the preceding figures.

The server device 940 may comprise or employ one or more server programs that operate to perform various methodologies in accordance with the described embodiments. In one embodiment, for example, the server device 940 may implement some steps described with respect to server devices described in the preceding figures.

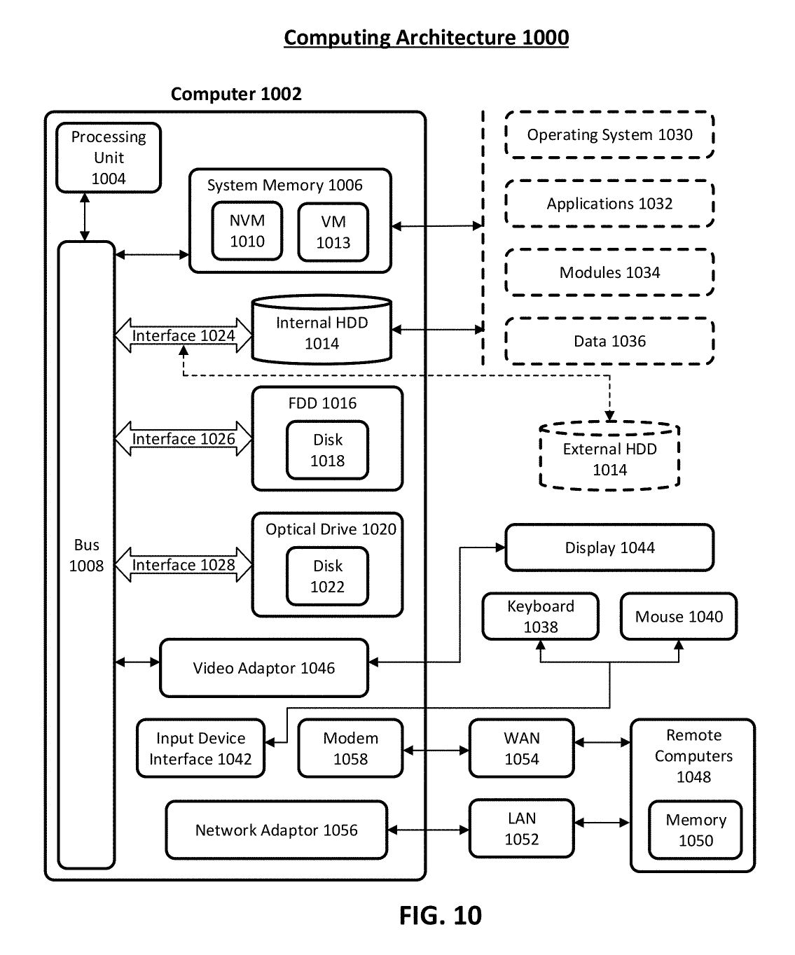

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described herein. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1013. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM, DVD, or Blu-ray). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1013, including an operating system 1030, one or more application programs 1032, other program modules 1034, and program data 1036. In one embodiment, the one or more application programs 1032, other program modules 1034, and program data 1036 can include, for example, the various applications and/or components to implement the disclosed embodiments.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A display 1044 is also connected to the system bus 1008 via an interface, such as a video adaptor 1046. The display 1044 may be internal or external to the computer 1002. In addition to the display 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

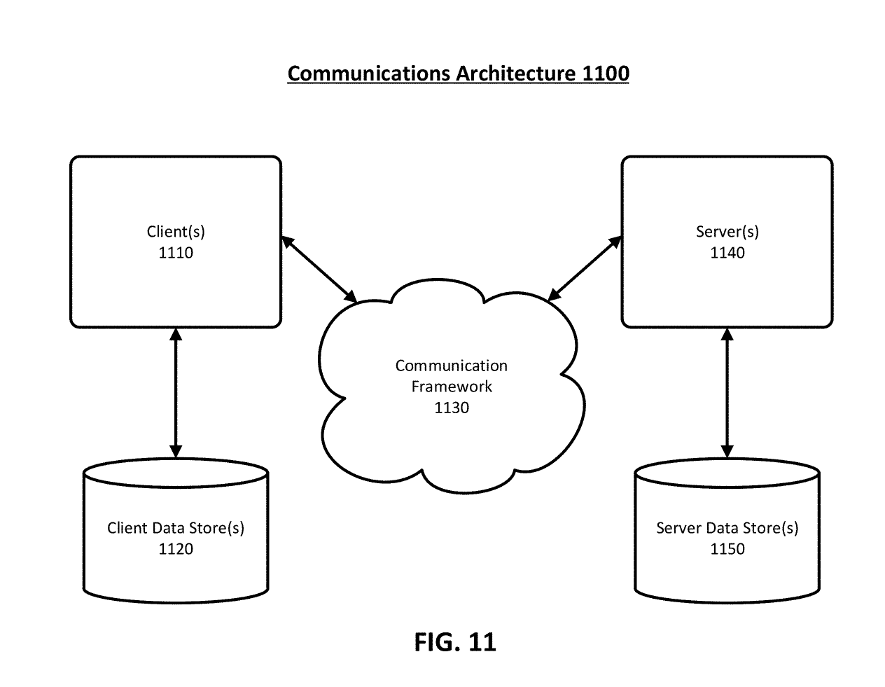

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1110 and servers 1140. The clients 1110 may implement the client device 910, for example. The servers 1140 may implement the server device 940, for example. The clients 1110 and the servers 1140 are operatively connected to one or more respective client data stores 1120 and server data stores 1150 that can be employed to store information local to the respective clients 1110 and servers 1140, such as cookies and/or associated contextual information.

The clients 1110 and the servers 1140 may communicate information between each other using a communication framework 1130. The communications framework 1130 may implement any well-known communications techniques and protocols. The communications framework 1130 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1130 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1110 and the servers 1140. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible.

1. A computer-implemented method, comprising:
receiving one or more electronic orders at a server;
identifying, automatically by the server, at least one electronic order of the one or more electronic orders that is of an OXQ type, wherein OXQ type orders include a trade acknowledge return time (TART) and maximum adverse change (MAC);
prioritizing the one or more orders primarily based upon TART and secondarily based upon MAC; and
matching, automatically by the server, the one or more orders based upon determined priority to create a matched trade.

2. The computer-implemented method of claim 1, wherein a trade confirmation is automatically generated in response to automatic matching of the one or more orders by the server.

3. The computer-implemented method of claim 1, wherein the one or more orders are foreign exchange (FOREX) orders.

4. The computer-implemented method of claim 1, wherein the one or more orders are placed via an executable streaming price (ESP) order adapter.

5. The computer-implemented method of claim 4, wherein the ESP order adapter supports Financial Information eXchange (FIX) or OUCH protocols.

6. The computer-implemented method of claim 1, wherein each of the one or more orders includes one or more of a client order ID, currency, side, symbol, transaction timestamp, order quantity, quantity currency, order type, or account ID.

7. The computer-implemented method of claim 1, wherein, prior to prioritization, the one or more orders are sorted by price.

8. The computer-implemented method of claim 1, wherein one or more unmatched orders trigger the server to automatically generate an internal deny, the internal deny not being shared outside the server.

9. An article including a non-transitory computer-readable storage medium including instructions, that, when executed by a processor, perform the computer-implemented method of:
receiving one or more electronic orders at a server;
identifying, automatically by the server, at least one electronic order of the one or more electronic orders that is of an OXQ type, wherein OXQ type orders include a trade acknowledge return time (TART) and maximum adverse change (MAC);
prioritizing the one or more orders primarily based upon TART and secondarily based upon MAC; and
matching, automatically by the server, the one or more orders based upon determined priority to create a matched trade.

10. The article of claim 9, wherein a trade confirmation is automatically generated in response to automatic matching of the one or more orders by the server.

11. The article of claim 9, wherein the one or more orders are foreign exchange (FOREX) orders.

12. The article of claim 9, wherein the one or more orders are placed via an executable streaming price (ESP) order adapter.

13. The article of claim 12, wherein the ESP order adapter supports Financial Information eXchange (FIX) or OUCH protocols.

14. The article of claim 9, wherein each of the one or more orders includes one or more of a client order ID, currency, side, symbol, transaction timestamp, order quantity, quantity currency, order type, or account ID.

15. The article of claim 9, wherein, prior to prioritization, the one or more orders are sorted by price.

16. The article of claim 9, wherein one or more unmatched orders trigger the server to automatically generate an internal deny, the internal deny not being shared outside the server.

17. An automated trade matching system, comprising:
a processor;
a matching engine executed by the processor and configured to:
receive one or more electronic orders at a server;
identify, automatically, at least one electronic order of the one or more electronic orders that is of an OXQ type, wherein OXQ type orders include a trade acknowledge return time (TART) and maximum adverse change (MAC);
prioritize the one or more orders primarily based upon TART and secondarily based upon MAC; and
match, automatically, the one or more orders based upon determined priority to create a matched trade.

18. The automated trade matching system of claim 17, wherein a trade confirmation is automatically generated in response to automatic matching of the one or more orders by the server.

19. The automated trade matching system of claim 17, wherein the one or more orders are foreign exchange (FOREX) orders.

20. The automated trade matching system of claim 17, wherein the one or more orders are placed via an executable streaming price (ESP) order adapter.

21. The automated trade matching system of claim 20, wherein the ESP order adapter supports Financial Information eXchange (FIX) or OUCH protocols.

22. The automated trade matching system of claim 17, wherein each of the one or more orders includes one or more of a client order ID, currency, side, symbol, transaction timestamp, order quantity, quantity currency, order type, or account ID.

23. The automated trade matching system of claim 17, wherein, prior to prioritization, the one or more orders are sorted by price.

24. The automated trade matching system of claim 17, wherein one or more unmatched orders trigger the server to automatically generate an internal deny, the internal deny not being shared outside the server.
